(19) United States
(12) Patent Application Publication
(10) Pub. No.: US 2026/0024506 A1
(43) Pub. Date: Jan. 22, 2026

(54) DISPLAY DEVICE AND DRIVING METHOD THEREOF

(71) Applicant: Japan Display Inc., Tokyo (JP)

(72) Inventors: Teppei YAMADA, Tokyo (JP); Hiroyuki ABE, Tokyo (JP); Masakatsu KITANI, Tokyo (JP)

(73) Assignee: Japan Display Inc., Tokyo (JP)

(21) Appl. No.: 19/225,170

(22) Filed: Jun. 2, 2025

(30) Foreign Application Priority Data
Jul. 19, 2024 (JP) 2024-115999

(51) Int. Cl. G09G 3/34; G09G 3/36

(52) U.S. Cl. CPC G09G 3/3426; G09G 3/3677; G09G 2310/0251; G09G 2310/08

(57) ABSTRACT

A display device includes a backlight unit, a plurality of pixels, a gate-line driver circuit, a signal-line driver circuit, and a control substrate. The plurality of pixels is so that light from the light-emitting element is incident and is arranged in a matrix form with a plurality of row and a plurality of columns. The control substrate is electrically connected to the backlight unit, the gate-line driver circuit, and the signal-line driver circuit. The plurality of rows is composed of a plurality of row groups having the same number of rows and sequentially arranged in a column direction. The control substrate is configured to, in a first frame period, to supply the same potential to all of the plurality of pixels to supply the gate-line driver circuit and the signal-line driver circuit with a control signal for performing a pre-charge.

### CROSS-REFERENCE TO RELATED APPLICATION

This application claims the benefit of priority to Japanese Patent Application No. 2024-115999, filed on Jul. 19, 2024, the entire contents of which are incorporated herein by reference.

### FIELD

An embodiment of the present invention relates to a display device and a driving method thereof.

### BACKGROUND

Liquid crystal displays have been used in a variety of electronic devices such as smartphones, cellular phones, tablets, televisions, computers, and digital signage. Hence, a variety of methods have been proposed to drive liquid crystal displays depending on their size and application. For example, a blinking driving method in which the backlight is turned on only in a part of each frame period, an overlap driving method in which a plurality of pixels is driven so as to overlap each other, and the like have been proposed (see Japanese Laid-Open Patent Applications No. 2024-51618 and 2020-244121). It is possible to prevent image quality degradation caused by flicker and luminance deviation by employing these driving methods.

### SUMMARY

An embodiment of the present invention is a driving method of a display device. The display device includes a backlight unit having a light-emitting element and a plurality of pixels arranged so that light from the light-emitting element is incident. The plurality of pixels is arranged in a matrix form having a plurality of rows and a plurality of columns. The plurality of rows is composed of a plurality of row groups having the same number of rows and sequentially arranged in a column direction. The driving method includes, in a first frame period, simultaneously supplying the same potential to all of the plurality of pixels to perform a pre-charge, and sequentially supplying an image signal to every row group after completing the pre-charge to supply the image signal to the pixels in each of the plurality of row groups.

An embodiment of the present invention is a display device. The display device includes a backlight unit including a light-emitting element, a plurality of pixels, a gate-line driver circuit, a signal-line driver circuit, and a control substrate. The plurality of pixels is arranged so that light from the backlight unit is incident and is arranged in a matrix form having a plurality of rows and a plurality of columns. The gate-line driver circuit and the signal-line driver circuit are each electrically connected to the plurality of pixels. The control substrate is electrically connected to the backlight unit, the gate-line driver circuit, and the signal-line driver circuit. The plurality of rows is composed of a plurality of row groups having the same number of rows and sequentially arranged in a column direction. The control substrate is configured to, in a first frame period, simultaneously supply the same potential to all of the plurality of pixels to perform a pre-charge and sequentially supply an image signal to every row group after the pre-charge is completed so that the gate-line driver circuit and the signal-line driver circuit are supplied with a control signal for supplying the image signal to the pixels in each of the plurality of row groups.

### BRIEF DESCRIPTION OF DRAWINGS

FIG. 1 is a schematic developed view of a display device according to an embodiment of the present invention.

FIG. 2 is a schematic top view of a display device according to an embodiment of the present invention.

FIG. 3 is an equivalent circuit diagram of a display device according to an embodiment of the present invention.

FIG. 4 is a schematic cross-sectional view of a display device according to an embodiment of the present invention.

FIG. 5 is a schematic cross-sectional view of a display device according to an embodiment of the present invention.

FIG. 6 is a timing chart showing a driving method of a display device according to an embodiment of the present invention.

FIG. 7 is a timing chart showing a driving method of a display device according to an embodiment of the present invention.

FIG. 8 is a timing chart showing a driving method of a conventional display device.

FIG. 9 is a timing chart showing a driving method of a display device according to an embodiment of the present invention.

FIG. 10 is a timing chart showing a driving method of a display device according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate. When a plurality of structures the same as or similar to each other is collectively represented, this reference number is used, while a hyphen and a natural number are added after the reference number when these structures are independently represented.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

### 1. Overall Structure of Display Device

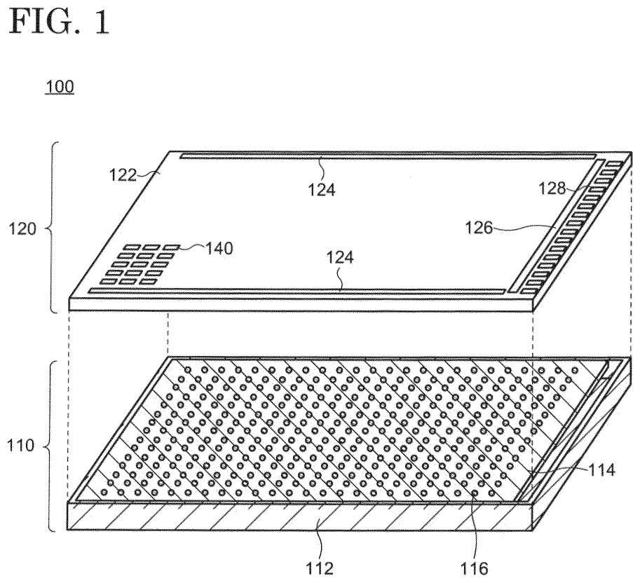

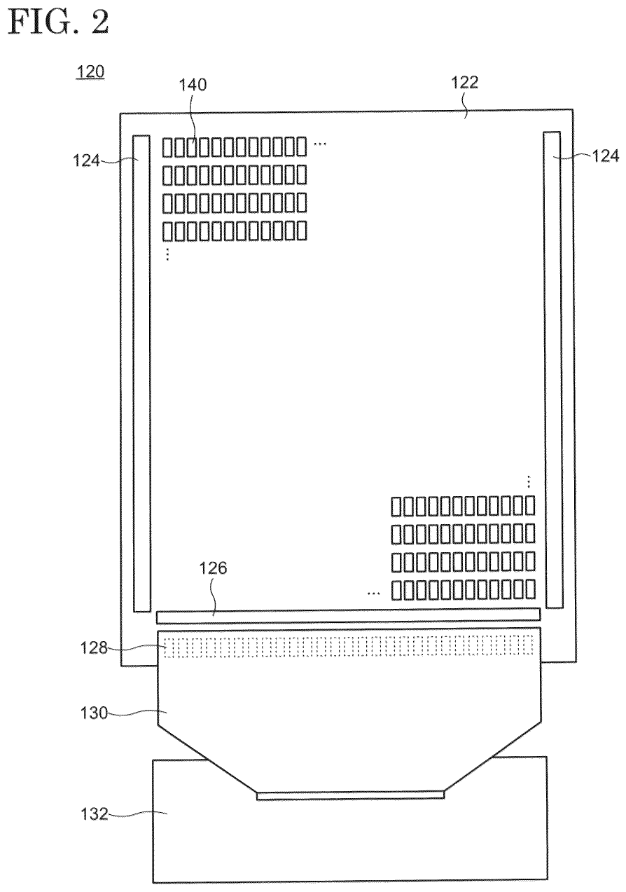

FIG. 1 and FIG. 2 respectively show schematic developed and top views of a display device 100 according to an embodiment of the present invention. The display device 100 is a liquid crystal display device and includes a backlight unit 110 and a display unit 120 arranged to overlap the backlight unit 110.

The backlight unit 110 is provided to supply light including visible light to the display unit 120 and has one or a plurality of light-emitting elements 116. The light-emitting elements 116 shown in FIG. 1 are inorganic light-emitting diodes (LEDs), and a plurality of light-emitting elements 116 is arranged over a light-source substrate 114. The light-source substrate 114 is disposed within a housing 112. Although not illustrated, an optical unit such as a light diffuser and a prism sheet is provided over the light-source substrate 114, which allows the light from the light-emitting elements 116 to be uniformly applied onto the display unit 120. The configuration of the backlight unit 110 is not limited to the configuration described above. For example, a plurality of LEDs arranged in one direction is used as the light-emitting elements 116, and the backlight unit 110 may be configured so that the light emitted therefrom is supplied to a side of the optical unit. Alternatively, a cold cathode tube may be used as the light-emitting element 116.

The display unit 120 has a substrate 122 and a counter substrate (not illustrated in FIG. 1 and FIG. 2) opposing the substrate 122. A variety of patterned conductive films, semiconductor films, insulating films, and the like formed using photolithography processes are arranged between the substrate 122 and the counter substrate. Appropriate combination of these conductive films, semiconductor films, and insulating films allows the formation of the plurality of pixels 140 each including a display element as well as driver circuits for driving the pixels 140 (gate-line driver circuit 124 and signal-line driver circuit 126) and a plurality of terminals electrically connected to the driver circuits. Note that a portion of the driver circuits (e.g., the whole of or a part of the signal-line driver circuit 126) may be formed using integrated circuits formed over a semiconductor substrate.

As shown in FIG. 2, the plurality of pixels 140 is arranged in a matrix form with a plurality of rows and a plurality of columns. As described below, each pixel 140 is provided with a liquid crystal display element as a display element and functions as the smallest unit providing color information. The smallest region including the plurality of pixels 140 and the region between adjacent pixels 140 is a display region, while the region surrounding the display region and provided with the driver circuits, the terminals 128, and the like is a frame region. Although not illustrated in FIG. 1 and FIG. 2, a plurality of gate lines, a plurality of image-signal lines, and the like are formed over the substrate 122 with patterned conductive films. The plurality of gate lines extends in the row direction from the gate-line driver circuit 124 to reach the display region, while the plurality of image-signal lines extends in the column direction from the signal-line driver circuit 126 to reach the display region.

The plurality of terminals 128 is arranged parallel to the row direction. The display unit 120 further includes a flexible printed circuit board (hereinafter, referred to as FPC) 130 electrically connected to the plurality of terminals 128 and a control substrate 132 electrically connected to the FPC 130. The control substrate 132 is located under the light-source substrate 114 and is accommodated in the housing 112. The control substrate 132 is configured to control the gate-line driver circuit 124 and the signal-line driver circuit 126. Specifically, a variety of control signals and power supplies for driving the display unit 100 are supplied to the driver circuits from the control substrate 132 via the FPC 130 and the terminals 128. The gate-line driver circuit 124 generates gate signals on the basis of the control signals supplied from the control substrate 132 and supplies these signals to the pixels 140 through the plurality of gate lines. Meanwhile, the signal-line driver circuit 126 generates a variety of signals including image signals on the basis of the control signals supplied from the control substrate 132 and supplies these signals to the pixels 140 through the plurality of image-signal lines. The plurality of pixels 140 is controlled by these signals, thereby reproducing images on the display region.

### 2. Pixels

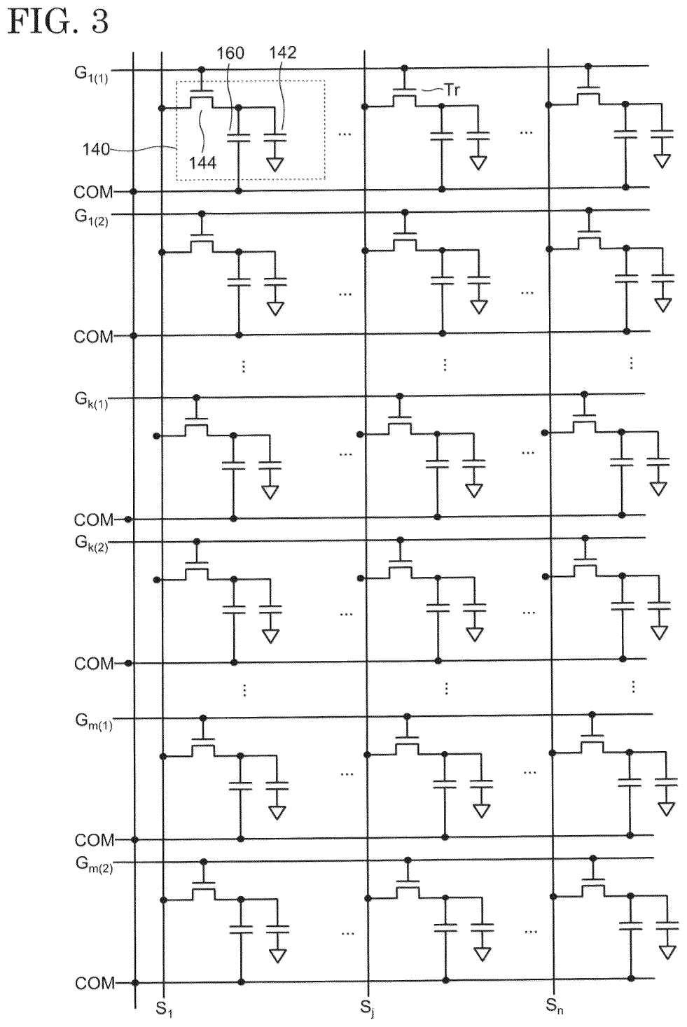

FIG. 3 shows an equivalent circuit diagram of the plurality of pixels 140. Here, some of the pixels 140 arranged in the first row to the 2m^{th} row and the first column to the n^{th} column are shown. m and n are independently set from each other and are each selected from integers equal to or greater than 2, preferably, equal to or greater than 4. There are no constraints on the maximum values of m and n, and the maximum values of m and n may be 2160 and 7680, respectively. Hereafter, k may be used as an integer arbitrarily selected from integers from 1 to m, and j may be used as an integer arbitrarily selected from integers from 1 to n.

A pixel circuit and the display element 160 are formed in each pixel 140. The pixel circuit is electrically connected to one corresponding gate line Gₖ₍₁₎ or Gₖ₍₂₎ and one corresponding signal line Sⱼ, and the display element 160 is electrically connected to a common wiring COM as well as the pixel circuit. Thus, one gate line Gₖ₍₁₎ or Gₖ₍₂₎ is electrically connected to n pixel circuits arranged in the row direction, while one signal line Sⱼ is electrically connected to 2m pixel circuits. The common wiring COM is electrically connected to the display elements 160 of all of the pixels 140. There are no restrictions on the configuration of the pixel circuit. For example, each pixel circuit may be structured by a switching transistor 144 and a capacitor element 142 as shown in FIG. 3. In this case, a gate of the switching transistor 144 is electrically connected to the gate line Gₖ₍₁₎ or Gₖ₍₂₎, one terminal is electrically connected to the signal line Sⱼ, and the other terminal is electrically connected to one terminal of the capacitor element 142 and the display element 160. The other terminal of the capacitor element 142 is electrically connected to a capacitor line (not illustrated) to which a constant potential is supplied. The configuration of the pixel circuit is also not limited to the configuration shown in FIG. 3, and each pixel circuit may further include one or a plurality of transistors and one or a plurality of capacitor elements.

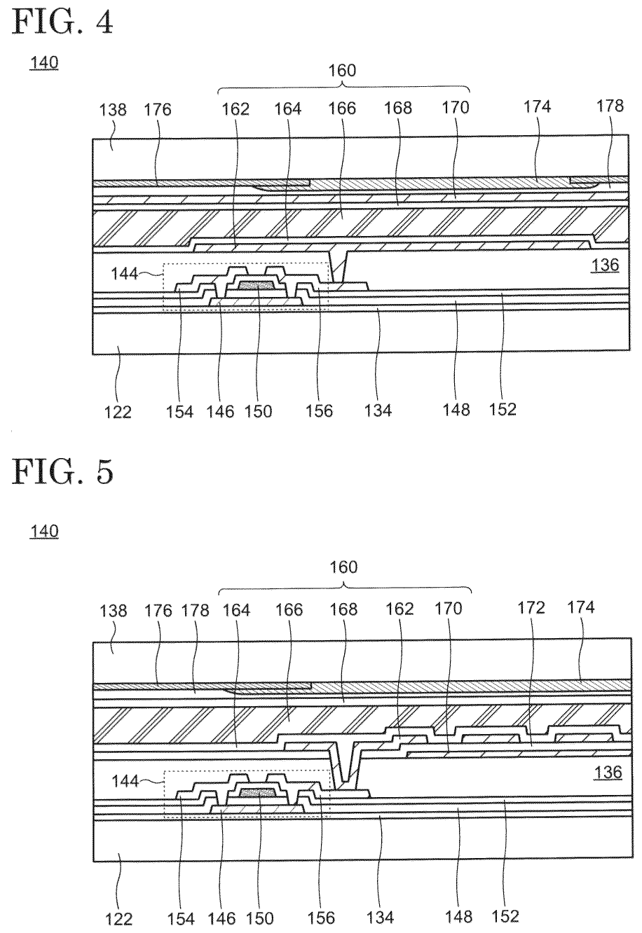

There are also no restrictions on the structure of the display element 160. For example, the display element 160 may be a so-called TN (Twist Nematic) liquid crystal display element or a so-called VA (Vertical Alignment) liquid crystal display element. A schematic cross-sectional view of the display unit 120 including one pixel 140 in this case is shown in FIG. 4. The elements structuring the pixel circuit (e.g., switching transistor 144) are provided over the substrate 122 either directly or over an undercoat 134 which is an optional component. In the example shown in FIG. 4, the switching transistor 144 is a top-gate type transistor and includes a semiconductor film 146, a gate insulating film 148 covering the semiconductor film 146, a gate electrode 150 overlapping the semiconductor film 146 through the gate insulating film 148, an interlayer insulating film 152 covering the gate electrode 150, and a pair of terminals 154 and 156 electrically connected to the semiconductor film 146 through openings in the interlayer insulating film 152 and the gate insulating film 148. The structure of the switching transistor 144 is not limited to the structure described above, and a bottom-gate type transistor may be employed as the switching transistor 144. Alternatively, the switching transistor 144 may be a transistor having a pair of gate electrodes vertically sandwiching a channel.

A leveling film 136 is provided over the pixel circuit to absorb unevenness caused by the switching transistor 144 and the like and to provide a flat surface, and the display element 160 is arranged over the leveling film 136. The display element 160 has a pixel electrode 162 electrically connected to the terminal 156, a first orientation film 164 over the pixel electrode 162, a liquid crystal layer 166 over the first orientation film 164, a second orientation film 168 over the liquid crystal layer 166, and a common electrode 170 over the second orientation film 168. Meanwhile, a color filter 174 overlapping the pixel electrode 162, a light-shielding film 176 provided to overlap the pixel circuit, an overcoat 178 disposed to cover the color filter 174 and the light-shielding film 176, and the like may be provided over the counter substrate 138 (in FIG. 4, under the counter substrate 138).

Alternatively, the display element 160 may be an IPS (In-Plane-Switching) type liquid crystal display element. In this case, the common electrode 170 is arranged over the leveling film 136, and the pixel electrode 162 having a comb-like top-surface shape is provided so as to overlap the common electrode 170 via an inter-electrode insulating film 172 as shown in FIG. 5. The first orientation film 164, the liquid crystal layer 166, and the second orientation film 168 are provided over the pixel electrode 162 and the common electrode 170.

### 3. Driving Method of Display Device

### 3-1. Frame Period

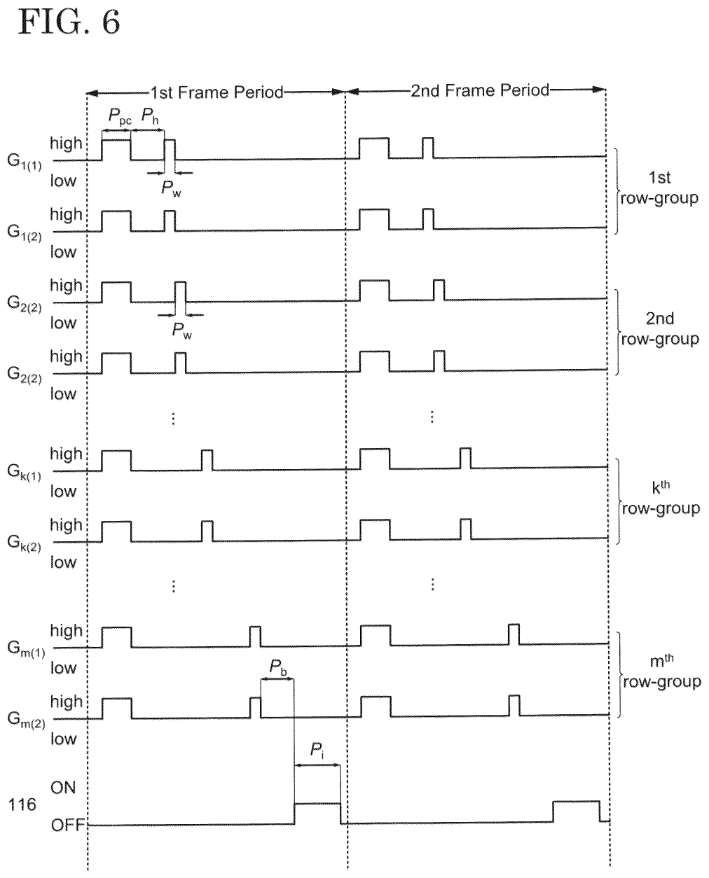

FIG. 6 shows a timing chart illustrating the driving method of the display device 100. This drawing shows the potential change of the gate line G₍₁₎ in the first row to the gate line G₂ₘ₍₂₎ in the 2m^{th} row and the operating state of the light-emitting element 116 over two consecutive frame periods (first frame period and second frame period). The time of each frame period may be arbitrarily set and may be selected from, for example, equal to or longer than 1/60 second and equal to or shorter than 1/240 second. In this driving method, each frame period is configured so that a pre-charge period P_{pc}, a holding period Pₕ, a writing period P_{w} to each pixel 140, a blanking period Pb, and an emission period Pᵢ proceed in sequence. The control substrate 132 is configured to supply the control signals to the gate-line driver circuit 124 and the signal-line driver circuit 126 so that the pixels 140 operate according to these periods and to control the light-emitting elements 116.

### (1) Pre-Charge Period

In the pre-charge period P_{pc}, the same potential is simultaneously supplied to all of the pixels 140 on the basis of the control signals from the control substrate 132. More specifically, all of the gate lines G₁₍₁₎ to G₂ₘ₍₂₎ are provided with a potential (in this case, high) to turn on the switching transistors 144. At this time, the same potential (pre-charge potential V_{Pc}) is provided to all of the signal lines S₁ to Sₙ. This operation allows the potential of the pixel electrodes 162 of all of the pixels 140 to be the same pre-charge potential V_{Pc}. Note that the potentials for turning the switching transistor 144 on and off depend on the polarity of the switching transistor 144. Therefore, the potentials to turn the switching transistor 144 on and off may be low and high, respectively, depending on the polarity of the switching transistor 144. The following description continues assuming that the potentials to turn the switching transistor 144 on and off are high and low, respectively.

### (2) Holding Period

When the pre-charge period P_{pc} ends, the holding period Pₕ starts. In the holding period Pₕ, the low potential is simultaneously supplied to all of the gate lines G₁₍₁₎ to G₂ₘ₍₂₎ on the basis of the control signals from the control substrate 132 to turn off the switching transistors 144, and thereafter, the potentials of all of the gate lines G₁₍₁₎ to G₂ₘ₍₂₎ are maintained low for a fixed period. This fixed period is the holding period Pₕ.

### (3) Writing Period

After the holding period Pₕ elapses, the writing period P_{w} starts, and image signals are written to the pixels 140 on the basis of the control signals from the control substrate 132. At this time, a gate-grouping driving method is adopted in which a pair of gate lines Gₖ₍₁₎ and Gₖ₍₂₎ adjacent to each other in the column direction is simultaneously driven. More specifically, the plurality of rows in which the pixels 140 are arranged is divided into a plurality (i.e., m) of row groups each containing the same number of rows. The plurality of row groups is arranged in order in the column direction. Here, each row group consists of two rows. Therefore, each row group includes two gate lines Gₖ₍₁₎ and Gₖ₍₂₎ adjacent to each other in the column direction as shown in FIG. 6. Specifically, the first row group includes two adjacent gate lines G₁₍₁₎ and G₁₍₂₎, and the second row group includes two adjacent gate lines G₂₍₁₎ and G₂₍₂₎. To generalize, the kth row group includes two gate lines Gₖ₍₁₎ and Gₖ₍₂₎ adjacent in the column direction, while the kth row group and the (k+1)th row group (k≠m) are adjacent in the column direction. The two gate lines included in each row group (i.e., two gate lines Gₖ₍₁₎ and Gₖ₍₂₎) are simultaneously driven. Therefore, the total number of gate lines is a multiple of 2, i.e., 2m.

Using the example shown in FIG. 6, the two gate lines G₁₍₁₎ and G₁₍₂₎ connected to the pixels 140 included in the first row group are first supplied with the high potential simultaneously during the writing period P_{w}. At this time, the low potential is maintained for all other gate lines. During the writing period P_{w} of the first row group, the image signals corresponding to the gradation of each pixel 140 are supplied to the signal lines S₁ to Sₙ. As a result, the image signals are written to the pixel electrodes 162 of the pixels 140 located in the first row and the second row. Therefore, the same potential is written to the pixels 140 located in the first row and the second row in each column.

When the writing of the image signals to the pixels 140 included in the first row group is completed, the gate lines G₁₍₁₎ and G₁₍₂₎ connected to the pixels 140 included in the first row group are supplied with the low potential, and the writing period P_{w} for the pixels 140 included in the second row group adjacent to the first row group in the column direction starts. That is, the high potential is supplied to the gate lines G₂₍₁₎ and G₂₍₂₎, and the image signals corresponding to the gradation of each pixel 140 are supplied to the signal lines S₁ to Sₙ. As a result, the image signals are written to the pixel electrodes 162 of the pixels 140 located in the third row and the fourth row. Therefore, the same potential is also written to the pixels 140 located in the third row and the fourth row in each column. Similar operations are performed sequentially to write the image signals to the pixels 140 in the m^{th} row group, thereby completing the writing of the image signals to all of the pixels 140.

### (4) Blanking Period

When the writing of the image signals to all of the pixels 140 is completed, the blanking period Pb starts. In this period, the potentials of all of the gate lines are set to the low potential on the basis of the control signals from the control substrate 132. Specifically, after the writing to all of the pixels 140 is completed (i.e., after the writing of the pixels 140 included in the m^{th} row group is completed), the low potential is maintained in all of the gate lines for a fixed period. The blanking period Pb may be set to be, for example, equal to or longer than 10% and equal to or shorter than 50% of one frame period.

### (5) Emission Period

After the blanking period Pb elapses, the light-emitting element 116 included in the backlight unit 110 is turned on on the basis of the control signals from the control substrate 132. The period during which the light-emitting element 116 is turned on, i.e., the emission period Pᵢ, may be set to be, for example, equal to or longer than 5% and equal to or shorter than 50% of one frame period. This operation allows the light from the light-emitting element 116 to passes through the pixels 140, providing the light with a gradation according to the image signal from each pixel 140. The light is also colored by the color filter 174. As a result, the color and the gradation of each pixel 140 are combined to form an image.

When the emission period Pᵢ elapses, the light-emitting element 116 included in the backlight unit 110 is turned off on the basis of the control signals from the control substrate 132. This operation ends one frame period (first frame period) and the subsequent frame period (second frame period) starts. The display unit 100 is driven in the same manner as in the first frame period in the second frame period.

### 3-2. Behavior of Pixel in Each Period

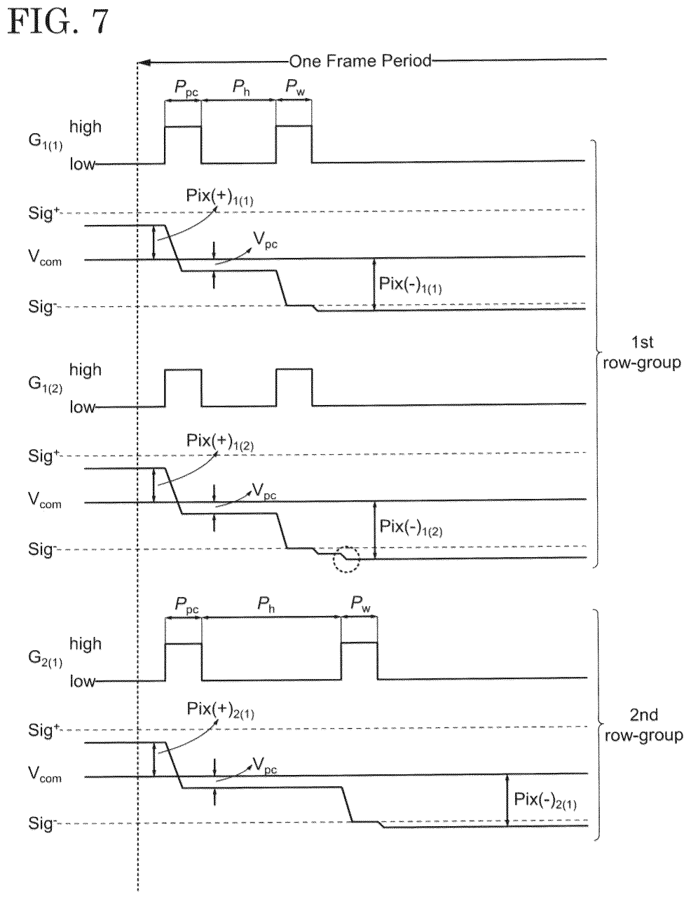

The behavior of pixels 140 in each period is explained in more detail using FIG. 7. FIG. 7 shows, in addition to the potential change of the common potential V_{com} provided to the common electrode in a portion of one frame period, the potential changes of two gate lines G₁₍₁₎ and G₁₍₂₎ driving the first row group and one gate line G₂₍₁₎ adjacent to the gate line G₁₍₂₎ in the column direction and driving the pixels 140 in the second row group and the potential change of the pixel electrodes 162 of the pixels 140 in one column connected to these gate lines.

In the display device 100, the so-called polarity-inversion driving method is employed. Therefore, the potential Sig of the image signal supplied from the signal line Sⱼ has a different polarity from each other with respect to the common potential V_{com} between the frame period shown in FIG. 7 and the frame periods before and after this frame. In the following description, the potential of the image signal is a negative potential Sig⁻ with respect to the common potential V_{com} in the frame period shown in FIG. 7 and is a positive potential Sig⁺ with respect to the common potential V_{com} in the frame periods before and after this frame period. The potentials of the pixel electrode 162 supplied with the potentials Sig⁺ and Sig⁻ in the emission period Pᵢ are denoted as Pix(+) and Pix(−), respectively. Note that the pixels 140 located in the same column are supplied with the image signals of the same polarity.

At the stage where one frame period starts, the potential of the pixel electrode 162 is the potential Pix(+) in the emission period P₁ of the preceding frame period. When the pre-charge period P_{pc} starts, the high potential is supplied to the gate lines connected to all of the pixels 140, thereby opening the pixel circuits of all of the pixels 140. In the pre-charge period P_{pc}, the same pre-charge potential V_{pc} is supplied from all of the signal lines. At this time, as shown in FIG. 7, the polarity of the pre-charge potential V_{pc} with respect to the common potential V_{com} is set to be a polarity different from that of the potential Sig⁺ of the image signals in the preceding frame period, that is, to be the same polarity as the potential Sig⁻ of the image signals supplied to the pixels 140 in the frame period in which this pre-charge is performed. In addition, the pre-charge is performed so that the magnitude of the pre-charge potential V_{pc} with respect to the common potential V_{com} is different from the common potential V_{com} and smaller than the potential of the image signal giving the maximum gradation. For example, the pre-charge potential V_{pc} may be set in the range equal to or greater than 20% and equal to or less than 80% of the image signal giving the maximum gradation.

When the pre-charge is completed to shift to the holding period Pₕ, the low potential is supplied to all of the gate lines, thereby closing the pixel circuits of all of the pixels 140. Therefore, the potentials of the pixel electrodes 162 are maintained at the pre-charge potential V_{pc} (or a potential lower than the pre-charge potential V_{pc} due to a phenomenon called gate field through) in all of the pixels 140. The holding period Pₕ allows the orientation of the liquid crystal molecules contained in the liquid crystal layer 166 to be completed in all of the pixels 140. The holding period Pₕ may be appropriately set within a range longer than 0% and equal to or shorter than 45% of the frame period.

After that, the image signals are sequentially written to the pixels 140 included in the first row group to the pixels 140 included in the m^{th} row group for every row group in the writing period P_{w}. For this purpose, the two gate lines G₁₍₁₎ and G₁₍₂₎ connected to the pixels 140 included in the first row group are simultaneously supplied with the high potential to open the pixel circuits of the pixels 140 included in the first row group. In addition, the image signals corresponding to the pixels 140 in each column are supplied through the signal line S₁ to the signal line Sₙ. In the example shown in FIG. 1, the image signal of the potential Sig-is written to the pixels 140 in one column. When the writing to these pixels 140 is completed, the low potential is simultaneously supplied to the gate lines G₁₍₁₎ and G₁₍₂₎, thereby closing the pixel circuits connected thereto. However, because of the phenomenon called gate field through, the potential of the pixel electrode 162 drops immediately after the pixel circuit is closed and changes to a value lower than the potential Sig-.

Then, the writing is performed to the pixels 140 included in the second row group. That is, the high potential is simultaneously supplied to the two gate lines G₂₍₁₎ and G₂₍₂₎ connected to the pixels 140 included in the second row group to open the pixel circuits of the pixels 140 included in the second row group. At the same time, the image signals corresponding to the pixels 140 in each column are supplied via the signal lines S₁ to Sₙ. As a result, the potential of the pixel electrodes 162 of the pixels 140 included in the second row group change from the pre-charge potential V_{pc} to the potential Sig-. When the writing to these pixels 140 is completed, the low potential is simultaneously supplied to the gate lines G₂₍₁₎ and G₂₍₂₎ to close the pixel circuits connected thereto. At this time, the potentials of the pixel electrodes 162 drop immediately after the pixel circuits are closed due to the gate field through phenomenon so that the potential Pix(−)₂₍₁₎ of the pixel electrodes 162 of the pixels 140 included in the second row group changes to a value lower than the potential Sig⁻.

Here, the pixel circuits of the pixels 140 included in the first row group are closed during the writing period P_{w} of the pixels 140 included in the second row group. In addition, there is a capacitance (Cₛₛᵥ) between the pixels adjacent in the column direction. Therefore, the pixels 140 of the first row group adjacent to the pixels 140 included in the second row group in the column direction, that is, the pixels 140 connected to the gate line G₁₍₂₎, are capacitively coupled by the potential variation of the pixel electrodes 162 of the pixels 140 included in the second row group, resulting in a decrease in potential of the pixel electrodes 162 as shown by the dotted circle of FIG. 7. Even though the same image signal is supplied, a difference may be generated between the potentials Pix(−)₁₍₁₎ and Pix(−)₁₍₂₎ of the pixel electrodes 162 of the pixels 140 respectively connected to the gate lines G₁₍₁₎ and G₁₍₂₎ due to this capacitive coupling (Cₛₛᵥ coupling), resulting in a difference in gradation between these pixels. Since the Cₛₛᵥ coupling occurs between adjacent row groups, a difference may also be generated between the potentials Pix(−)ₖ₍₁₎ and Pix(−)ₖ₍₂₎ of the pixel electrodes 162 of the pixels 140 respectively connected to the gate lines Gₖ₍₁₎ and Gₖ₍₂₎ of the same row group. When such a gradation difference occurs, streaks may be visible in the row direction in the images, resulting in a decrease in image quality.

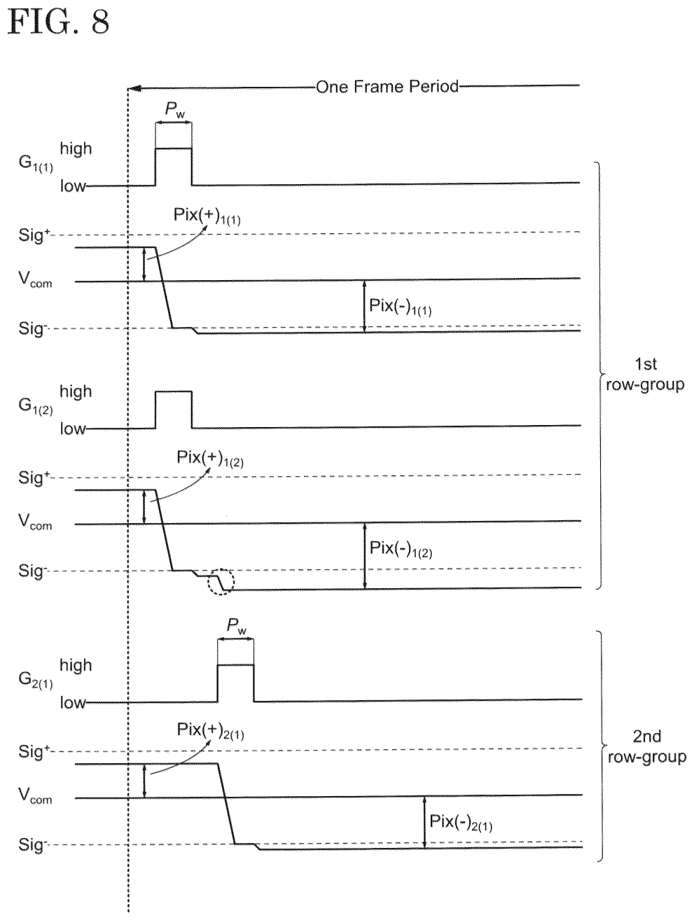

However, since the pre-charge period P_{pc} is provided in this driving method, the influence of the Cₛₛᵥ coupling can be significantly reduced compared with the driving method without the pre-charge period P_{pc}. FIG. 8 shows a timing chart of a driving method without the pre-charge period P_{pc}. When the pre-charge period P_{pc} is not provided, the potential change of the pixel electrode 162 in each pixel 140, which is caused when the image signal is written, is the difference between two potentials with different polarity, i.e., a difference between the potential Pix(+)ₖ₍₁₎ or Pix(+)₍ₖ₍₂₎ of the pixel electrode 162 in the preceding frame period and the potential Sig⁻ of the image signal supplied in that frame period (Pix(+)ₖ₍₁₎−Sig⁻ or Pix(+)ₖ₍₂₎−Sig⁻). In contrast, the potential change of the pixel electrode 162 caused by the writing of the image signal is a difference between the pre-charge potential V_{pc} and the potential Sig-of the image signal (V_{pc})−Sig⁻) in this driving method. As described above, the polarity of the pre-charge potential V_{pc} and the image signal potential Sig-is identical. Therefore, the potential change of the pixel electrode 162 caused by the writing of the image signal can be reduced by providing the pre-charge period P_{pc} so that the influence of the Cₛₛᵥ coupling can be significantly reduced. As a result, the gradation difference between the pixels 140 adjacent in the column direction in the same row group can also be greatly reduced, and high-quality images can be provided even if the gate-grouping driving method is adopted. The gate-grouping driving method is a driving method capable of achieving both high resolution and responsiveness and is suitable, for example, for small head-mounted display devices used for games and VR displays. Therefore, a high-resolution and high-speed responsive display device capable of providing high-quality images can be realized by implementing the embodiment of the present invention.

Furthermore, the blanking period Pb having a fixed period is provided after the writing of the image signals to all of the pixels 140 is completed in the display device 100. This feature allows the liquid crystal molecules contained in the liquid crystal layer 166 to have the period necessary to take an alignment state in accordance with the potential Sig⁺ or Sig of the image signals. Furthermore, the control substrate 132 is configured to turn on the light-emitting element 116 of the backlight unit 110 after the blanking period Pb elapses and to turn off the light-emitting element 116 after the lighting period Pᵢ with a fixed period elapses and when or before shifting to the following frame period. In other words, the light-emitting element 116 is not turned on during the writing period P_{w} as well as the pre-charge period P_{pc}, the holding period Pₕ, and the blanking period Pb. Therefore, light having the gradation determined by the pre-charge potential V_{pc} is not emitted from the pixel 140 in one frame period. Moreover, light of the gradation determined by the state of the liquid crystal molecules before shifting to the orientation state according to the image signal potential Sig⁺ or Sig⁻ is not emitted from the pixel 140. Therefore, all of the pixels 140 are able to emit light accurately reflecting the gradation determined by the control signals supplied from the control substrate 132 in each frame period, thereby preventing display defects.

### 4. Modified Examples

The display device 100 and the driving method thereof are not limited to the examples described above. Hereinafter, modified examples of the display device 100 and its driving method are described.

### 4-1. Modified Example 1

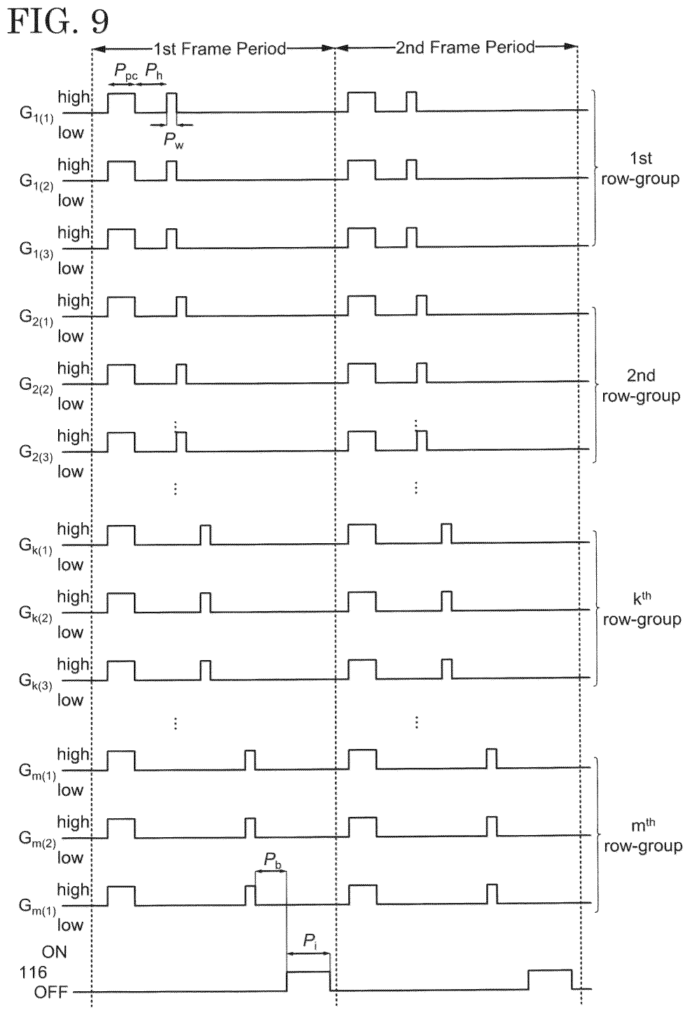

Although each row group is composed of two rows in the example described above, the number of rows constituting each row group is arbitrary and may be three as shown in FIG. 9. In this case, the total number of gate lines is a multiple of 3 (3m). In the writing period P_{w}, the high potential is simultaneously supplied to the three consecutive gate lines in the column direction within each row group, and the image signals are written to the pixels in each row group. Although there is no restriction on the maximum number of rows constituting each row group, the number is preferably 3 or 4.

### 4-2. Modified Example 2

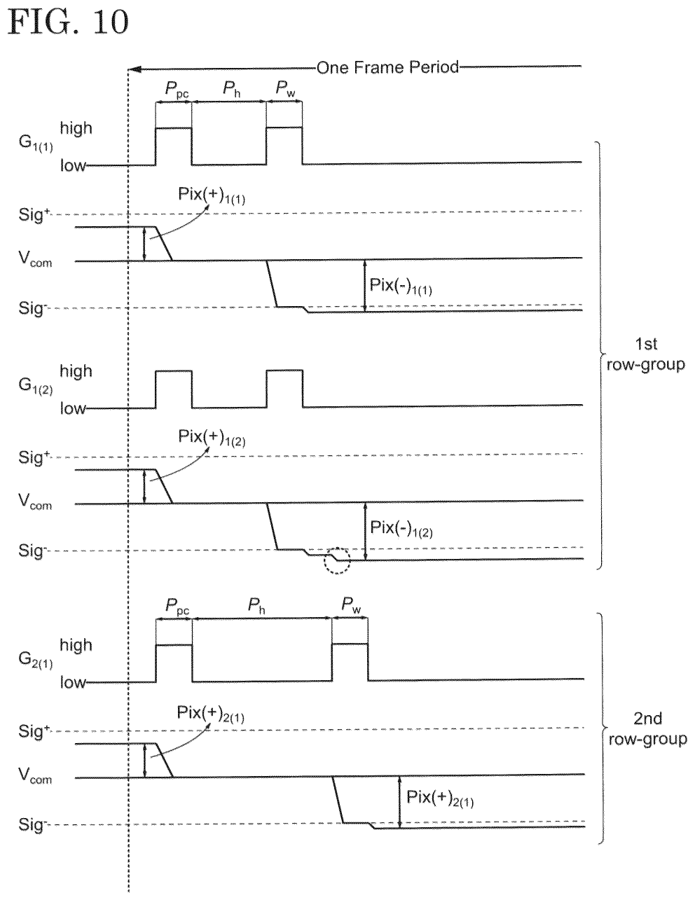

In the above example, the pre-charge potential V_{pc} supplied to the pixel electrodes 162 during the pre-charge period Pc is different from the common potential V_{com}, and the polarity thereof with respect to the common potential V_{com} is the same as that of the potential Sig⁺ or Sig of the image signals. However, the pre-charge potential V_{pc} may also be arbitrarily set. For example, the pre-charge potential V_{pc} may be the same as the common potential V_{com} as shown in FIG. 10. Even in this case, compared with the driving method without the pre-charge period Pc, the potential change of the pixel electrode 162 during the writing period P_{w} is smaller by Pix(+) or Pix(−) of the potential of the pixel electrode 162 in the preceding frame period. Therefore, the influence of the Cₛₛᵥ coupling (potential variation indicated by the dotted circle in the drawing) can be significantly reduced.

Although not illustrated, the pre-charge potential V_{pc} may be varied for each frame period. For example, a potential between the potential Sig of the image signal of the pixel 140 with the highest gradation in each frame period and the common potential V_{com} may be employed as the pre-charge potential V_{pc}, and the control substrate 132 may be configured to change the pre-charge potential V_{pc} for each frame period.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of each embodiment is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. A driving method of a display device comprising a backlight unit including a light-emitting element and a plurality of pixels arranged so that light from the light-emitting element is incident, the plurality of pixels being arranged in a matrix form having a plurality of rows and a plurality of columns wherein the plurality of rows is composed of a plurality of row groups having the same number of rows and sequentially arranged in a column direction, the driving method comprising, in a first frame period:
simultaneously supplying the same potential to all of the plurality of pixels to perform a pre-charge; and
sequentially supplying an image signal to every row group after completing the pre-charge to supply the image signal to the pixels in each of the plurality of row groups.

2. The driving method according to claim 1, further comprising turning on the light-emitting element after the image signal is supplied to all of the plurality of pixels.

3. The driving method according to claim 2, further comprising turning off the light-emitting element before performing the pre-charge in a second frame period following the first frame period.

4. The driving method according to claim 1,
wherein a period after completing the supply of the image signal to all of the plurality of pixels and before turning on the light-emitting element is equal to or greater than 10% and equal to or less than 50% of the first frame period.

5. The driving method according to claim 1,
wherein each of the plurality of pixels comprises a pixel electrode, a common electrode, and a liquid crystal layer between the pixel electrode and the common electrode,
the potential supplied in the pre-charge is supplied to the pixel electrode, and
the potential is the same as a potential supplied to the common electrode.

6. The driving method according to claim 1,
wherein each of the plurality of pixels comprises a pixel electrode, a common electrode, and a liquid crystal layer between the pixel electrode and the common electrode,
the potential supplied in the pre-charge is supplied to the pixel electrode, and
the potential has the same polarity as a potential of the image signal with respect to a potential supplied to the common electrode.

7. The driving method according to claim 1,
wherein each of the plurality of pixels comprises a pixel electrode, a common electrode, and a liquid crystal layer between the pixel electrode and the common electrode, and
a polarity of a potential of the image signal with respect to a potential supplied to the common electrode is different between the first frame period and a second frame period following the first frame period.

8. The driving method according to claim 1,
wherein the number of rows of each of the plurality of row groups is equal to or greater than 2 and equal to or less than 4.

9. A display device comprising:
a backlight unit including a light-emitting element;
a plurality of pixels arranged so that light from the backlight unit is incident and arranged in a matrix form having a plurality of rows and a plurality of columns;
a gate-line driver circuit and a signal-line driver circuit each electrically connected to the plurality of pixels; and
a control substrate electrically connected to the backlight unit, the gate-line driver circuit, and the signal-line driver circuit,
wherein the plurality of rows is composed of a plurality of row groups having the same number of rows and sequentially arranged in a column direction, and
the control substrate is configured to, in a first frame period,
simultaneously supply the same potential to all of the plurality of pixels to perform a pre-charge, and
sequentially supply an image signal to every row group after the pre-charge is completed so that the gate-line driver circuit and the signal-line driver circuit are supplied with a control signal for supplying the image signal to the pixels in each of the plurality of row groups.

10. The display device according to claim 9,
wherein the control substrate is further configured to, in the first frame period, turn on the light-emitting element after the image signal is supplied to all of the plurality of pixels.

11. The display device according to claim 10,
wherein the control substrate is further configured to, in a second frame period following the first frame period, turn on the light-emitting element before performing the pre-charge.

12. The display device according to claim 9,
wherein a period after completing the supply of the image signal to all of the plurality of pixels and before turning on the light-emitting element is equal to or greater than 10% and equal to or less than 50% of the first frame period.

13. The display device according to claim 9,
wherein each of the plurality of pixels comprises a pixel electrode, a common electrode, and a liquid crystal layer between the pixel electrode and the common electrode,
the potential supplied in the pre-charge is supplied to the pixel electrode, and
the potential is the same as a potential supplied to the common electrode.

14. The display device according to claim 9,
wherein each of the plurality of pixels comprises a pixel electrode, a common electrode, and a liquid crystal layer between the pixel electrode and the common electrode,
the potential supplied in the pre-charge is supplied to the pixel electrode, and
the potential has the same polarity as a potential of the image signal with respect to a potential supplied to the common electrode.

15. The display device according to claim 9,
wherein each of the plurality of pixels comprises a pixel electrode, a common electrode, and a liquid crystal layer between the pixel electrode and the common electrode, and
a polarity of a potential of the image signal with respect to a potential supplied to the common electrode is different between the first frame period and a second frame period following the first frame period.

16. The display device according to claim 9,
wherein the number of rows of each of the plurality of row groups is equal to or greater than 2 and equal to or less than 4.
